(19) United States
(12) Patent Application Publication
(10) Pub. No.: US 2025/0258722 A1
(43) Pub. Date: Aug. 14, 2025

(54) IMPUTATION OF AUTOMATED AGENT DECISION LOGIC

(71) Applicant: Scaled Cognition, Inc., Amesbury, MA (US)

(72) Inventors: Dan Klein, Berkeley, CA (US); Mathew Gardner, Irvine, CA (US); Emmanouil Antonios Platanios, Fremont, CA (US); Mitchell Stern, Berkeley, CA (US); Adam Pauls, Berkeley, CA (US)

(73) Assignee: Scaled Cognition, Inc., Amesbury, MA (US)

(21) Appl. No.: 18/750,149

(22) Filed: Jun. 21, 2024

Related U.S. Application Data
(60) Provisional application No. 63/551,534, filed on Feb. 9, 2024.

(51) Int. Cl. G06F 9/54

(52) U.S. Cl. CPC G06F 9/541

(57) ABSTRACT

A system automatically imputes automated agent decision logic. An interaction record is used with other data to determine an optimal and efficient logical path from a starting point in an interaction record to the end of the interaction record between an automated agent and a client. The logical path can be determined using a process that works backward, from the end point to the starting point, to determine the optimal path. Once complete, the resulting interaction record is supplemented with additional information regarding what states and/or steps were taken in the agent architecture specification to navigate through the interaction record.

### CROSS REFERENCE TO RELATED APPLICATIONS

The present application claims the priority benefit of U.S. provisional patent application 63/551,534, filed on Feb. 9, 2024, titled “Imputation of Automated Agent Decision Logic from Interaction Records,” the disclosure of which is incorporated herein by reference.

### BACKGROUND

described, automatically imputes automated agent decision logic. An interaction record is used with other data to determine an optimal and efficient logical path from a starting point in an interaction record to the end of the interaction record between an automated agent and a client. The logical path can be determined using a process that works backward, from the end point to the starting point, to determine the optimal path. Once complete, the resulting interaction record is supplemented with additional information regarding which states and/or steps were taken in the agent architecture specification to navigate through the interaction record.

The present system accesses an interaction record, an application program interface (API) specification, and an agent architecture specification to supplement an interaction record. The interaction record can include a conversational record of messages exchanged between an automated agent and a client in the past. Hence, the interaction record is associated with an interaction that has already taken place. An API specification is a specification of the programs that can be executed by the automated agent. The agent architecture specification can include logic that the automated agent uses to perform actions as part of the agent functionality. The logic can include a flow chart, state machine, or other decision process through which the optimal path or “golden path” can be imputed.

In some instances, the present technology performs a method for generating a supplemented interaction record between an automated agent and a client. The method begins with accessing, by an imputation engine on a server, an existing interaction record between a client and an automated agent, an API specification, and an agent architecture specification. The existing interaction record is associated with an interaction between the client and the automated agent that occurred in the past, and includes at least one entry associated with an automated agent. The method continues by determining one or more logical steps performed by an automated agent in determining each entry by the automated agent in the existing interaction record. A supplemented interaction record is generated based on the existing interaction record between a client and an automated agent, an API specification, and an agent architecture specification. The supplemented interaction record includes additional data based on the one or more logical steps performed by the automated agent.

In some instances, the present technology includes a non-transitory computer readable storage medium having embodied thereon a program, the program being executable by a processor to generate a supplemented interaction record between an automated agent and a client. The method begins with accessing, by an imputation engine on a server, an existing interaction record between a client and an automated agent, an API specification, and an agent architecture specification. The existing interaction record is associated with an interaction between the client and the automated agent that occurred in the past, and includes at least one entry associated with an automated agent. The method continues by determining one or more logical steps performed by an automated agent in determining each entry by the automated agent in the existing interaction record. A supplemented interaction record is generated based on the existing interaction record between a client and an automated agent, an API specification, and an agent architecture specification. The supplemented interaction record includes additional data based on the one or more logical steps performed by the automated agent.

In some instances, the present technology includes a system having one or more servers, each including memory and a processor. One or more modules are stored in the memory and executed by one or more of the processors to access, by an imputation engine on a server, an existing interaction record between a client and an automated agent, an API specification, and an agent architecture specification, the existing interaction record associated with an interaction between the client and the automated agent that occurred in the past, the existing interaction record including at least one entry associated with an automated agent, determine one or more logical steps performed by an automated agent in determining each entry by the automated agent in the existing interaction record, and generate a supplemented interaction record based on the existing interaction record between a client and an automated agent, an API specification, and an agent architecture specification, the supplemented interaction record including additional data based on the one or more logical steps performed by the automated agent.

### BRIEF DESCRIPTION OF FIGURES

FIG. 1 is a block diagram of a system for imputing automated agent decision logic.

FIG. 2 is a block diagram of an automated agent application.

FIG. 3 is a block diagram illustrating the data flow for an imputation engine.

FIG. 4 illustrates an interaction record between an automated agent and a client.

FIG. 5 illustrates an agent architecture specification.

FIGS. 6-11 illustrate supplemented interaction records.

FIG. 12 is a flow chart illustrating data flow for a large language model.

FIG. 13 is a method for imputing automated agent decision logic.

FIG. 14 is a method for generating supplemented interaction record data.

FIG. 15 is a method for generating a response.

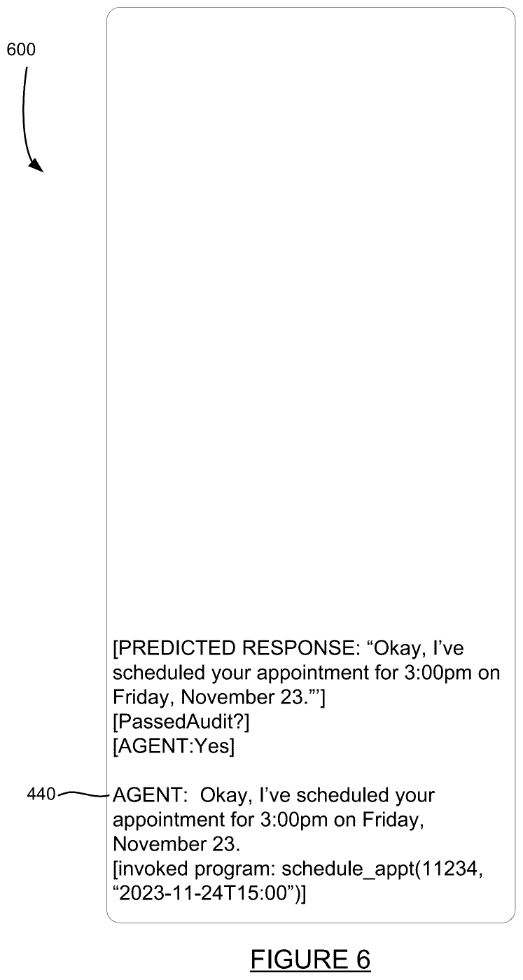

FIG. 6 is a method for generating supplemented interaction record data using a large language model (LLM).

FIGS. 17 is a method for calculating closeness of a generated supplemented interaction record data.

FIG. 18 is a block diagram of a computing environment.

### DETAILED DESCRIPTION

The present technology automatically imputes automated agent decision logic. An interaction record is used with other data to determine an optimal and efficient logical path from a starting point in an interaction record to the end of the interaction record between an automated agent and a client. The logical path can be determined using a process that works backward, from the end point to the starting point, to determine the optimal path. Once complete, the resulting interaction record is supplemented with additional information regarding what states and/or steps were taken in the agent architecture specification to navigate through the interaction record.

The present system accesses an interaction record, an API specification, and an agent architecture specification to supplement an interaction record. The interaction record can include a conversational record of messages exchanged between an automated agent and a client in the past. Hence, the interaction record is associated with an interaction that has already taken place. An API specification is a specification of the programs that can be executed by the automated agent. The agent architecture specification can include logic that the automated agent uses to perform actions as part of the agent functionality. The logic can include a flow chart, state machine, or other decision process through which the optimal path or “golden path” can be imputed.

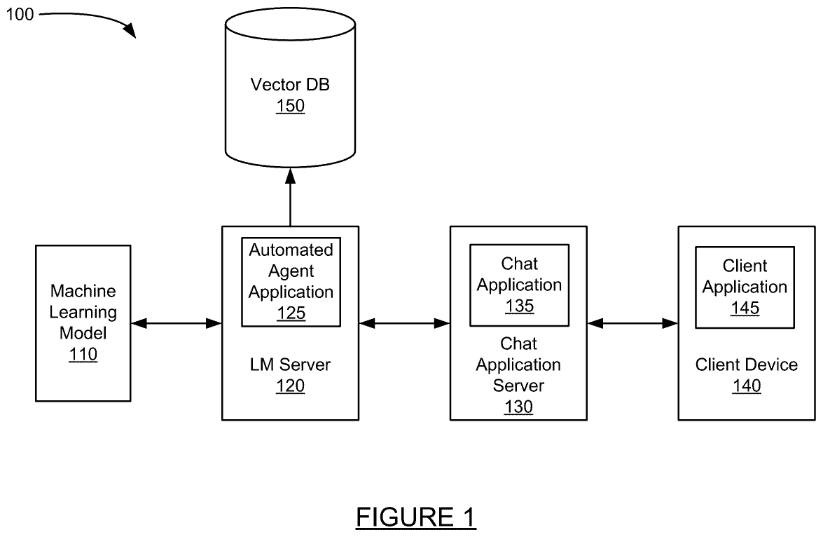

FIG. 1 is a block diagram of a system for imputing automated agent decision logic. System 100 of FIG. 1 includes machine learning model 110, language model server 120, chat application server 130, client device 140, and vector database 150. Machine learning model 110 may be implemented locally or remote from language model server 120. The model 110 may be implemented as one or more machine learning models, large language models, or other learning models.

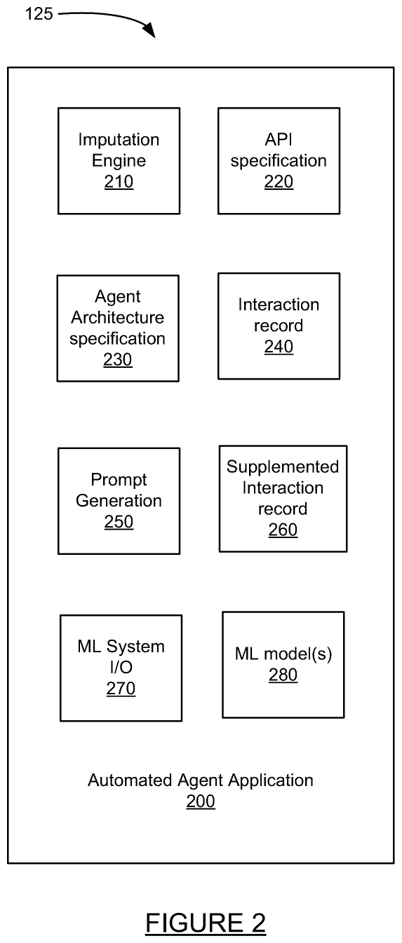

Language model server 120 may be implemented as one or more servers or machines over one or more platforms to perform the technology described herein. Language model server 120 may include one or more automated agent application 125. The automated agent application may generate prompts, communicate with machine learning models, impute interaction records, and perform other functionality as described herein. Automated agent application 125 is discussed in more detail with respect to FIG. 2.

Chat application server 130 may host and manage a conversation between an automated agent associated with language model server 120 and a client associated with client device 140. Server 130 may include a chat application 135, which can communicate with one or more servers 120 and one or more client devices 140. Chat application 135 may implement a chat or other electronic interaction, handle communications between servers 120 and device 140, and perform other functions related to an interaction between an automated agent and a client.

Client device 140 may include client application 145. Client device 140 may be used to interact with chat application 135 on behalf of a client which interacts with client application 145. The client device may be implemented as a mobile device, a computer, work station, a robotic device, and/or another computing device.

Vector database 150 may communicate with server 120, server 130, client device 140, and machine learning model 110. In some instances, vector database 150 may store data associated with an interaction record, supplemented interaction record, an API specification, a specification of an agent architecture, machine learning model data, large language model data, including content, requests, and instructions for one or more prompts, and other data for use with the functionality described herein.

Vector database 150 may be implemented as a data store that stores vector data. In some instances, vector database 135 may be implemented as more than one data store, internal to system 103 and exterior to system 103. In some instances, a vector database can serve as an LLMs' long-term memory and expand an LLMs' knowledge base. Vector database 135 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers. Vector database 150 may include data such as prompt templates, instructions, training data, and other data used by LM application 125 and machine learning model 110.

In some instances, the present system may include one or more additional data stores, in place of or in addition to vector database 150, at which the system stores searchable data such as instructions, private data, domain-specific data, and other data.

Each of model 110, servers 120-140, and vector database 150 may communicate over one or more networks. The networks may include one or more the Internet, an intranet, a local area network, a wide area network, a wireless network, Wi-Fi network, cellular network, or any other network over which data may be communicated.

FIG. 2 is a block diagram of an automated agent application. The block diagram of FIG. 2 provides more detail for application 125 of the system of FIG. 1. Automated agent application 200 includes imputation engine 210, API specification 220, agent architecture specification 230, interaction record 240 (for an interaction that has taken place previously), prompt generation 250, supplemented interaction record 260, machine learning system I/O 270, and machine learning model(s) 280.

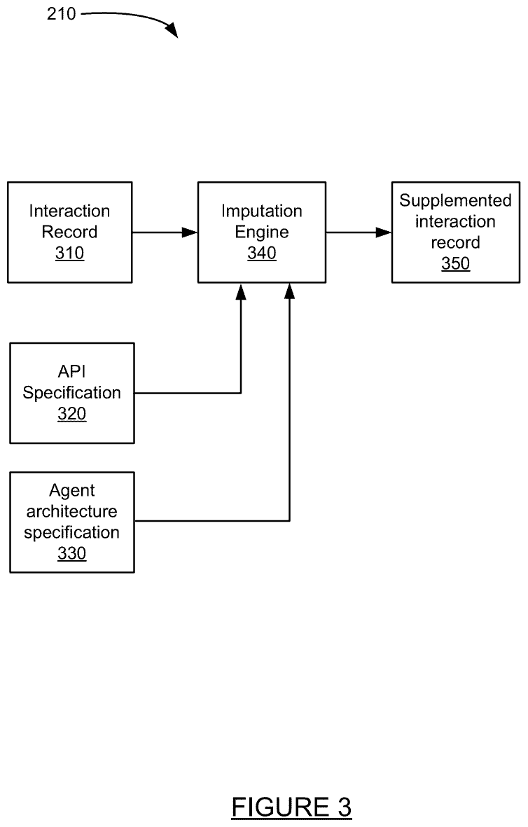

Imputation engine 210 determines an optimal or most efficient path using the agent architecture specification from a start point in an interaction record to an end point in the specification record. The imputation engine accesses input of an interaction record 240, API specification 220, and agent architecture specification 230. Based on the accessed input, the imputation engine determines a sequence of steps that form the optimal path between each record end point. The imputation engine 210 creates a supplemented interaction record that includes the interaction record as well as the results of each logical step by the automated agent in creating each response or message in the record by the automated agent. Imputation engine 210 is discussed in more detail with respect to FIG. 3.

API specification 220 includes a specification of the programs which are executable by the automated agent. The API specification may include information about the APIs, parameters for executing them, their variables, and other content.

Agent architecture specification 230 may include logic for processing client requests received through an interaction with a client. In some instances, imputation engine 210 may be implemented as a flowchart, state machine, or other decision process. The Agent architecture specification is used by the imputation engine along with the API specification to determine the most efficient path or “golden path” between an initial entry and a final entry in an interaction record 240 between the automated agent and a client. The most efficient path can be determined from the beginning moving forward or beginning from the last entry in the interaction and moving backwards. Regardless of the direction, each step in the path is determined at least in part using logic contained in the Agent architecture specification.

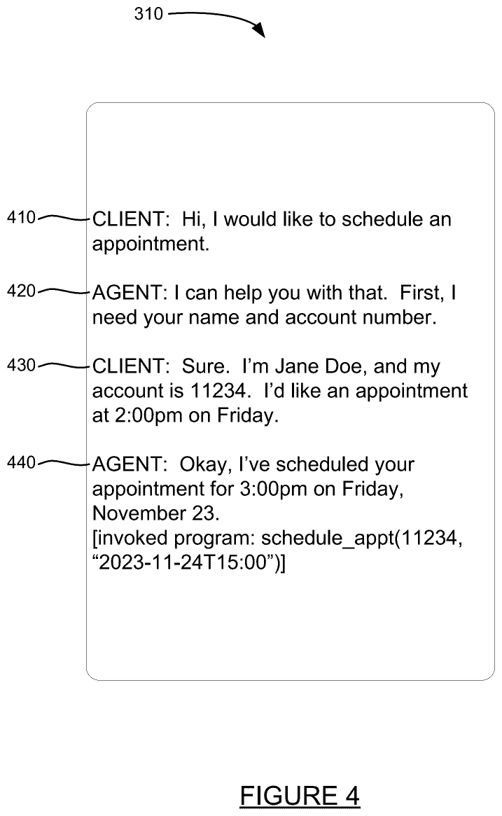

Interaction record 240 may include a record of the exchange between an automated agent and a client. The action typically only includes the exchanged messages between the agent and the client, without information about APIs called, programs executed, and other actions taken by the automated agent during an interaction with a client. An example of an interaction record is illustrated in FIG. 4.

Supplemented interaction record 260 is generated from an interaction record using an API specification and an agent architecture specification. The supplemented interaction record includes decisions and program results as the automated agent used agent decision logic.

Prompt generation 250 may generate a prompt for a large language model. The prompt may be generated with request, instructions, and other content. Prompt generation 220 may access the prompt elements, construct the prompt, and provide the prompt to ML system I/O 230 for transmission to a machine learning model.

Machine learning system I/O 270 may communicate with internal or external machine learning systems. The system may provide input in the form of serial data, streaming data, or a prompt to an external machine learning model, and can receive output from a machine learning model or LLM. The machine learning system I/O module may also communicate with other modules within application 200.

Machine learning models 280 may be implemented locally on server 120 or remotely, such as for example as machine learning model 110 in the system of FIG. 1. Machine learning models 280 may be implemented as a machine learning model, large language model, or other ML system. The machine learning models 240 may be used to predict states within imputation engine 210, generate supplemented interaction records, and perform other functions.

Modules illustrated in language model application 200 are exemplary, and could be implemented in additional or fewer modules. Language model application 200 is intended to at least implement functionality described herein. The design of specific modules, objects, programs, and platforms to implement the functionality is not specific and limited by the modules illustrated in FIG. 2.

FIG. 3 is a block diagram illustrating the data flow for an imputation engine. An imputation engine 340 can access and/or receive an interaction record 310, API specification 320, and an agent architecture specification 330. The record 310 and specifications 320-330 are used by the imputation engine to generate a supplemented interaction record 350. The supplemented interaction record may be a statistical model learned from example conversations within the interaction record, and supplemented with information from the API specification and agent architecture specification.

An example of an interaction record is illustrated in FIG. 4. The interaction record of FIG. 4 includes 4 entries 410-440 in an interaction between a client and an automated agent. Entries 410 and 430 are initiated by a client and entries 420 and 440 are initiated by an automated agent. The automated agent entries are a response to a previous client entry or message. For each automated agent response, the automated agent progresses through an agent architecture specification, which can be represented as a state machine, flow chart, or other decision process. In response to each client entry or message, the automated agent may determine an action to take, whether it be to predict or generate a response, execute a program, or some other action. A path from the first entry in the interaction record to the last entry in the interaction record is determined based on the agent architecture specification applied in response to each client entry.

In the interaction record of FIG. 4, initially, the client indicates they would like to schedule an appointment. The agent receives the message, and, within the interaction, indicates that information is needed to proceed. The information includes the name and account number. The client provides the requested information, and also indicates that the appointment should be at 2 PM on Friday then responds that the appointment has been scheduled. The interaction record three include regarding the actions taken by the automated agent responding to the client.

The imputation agent determines the optimal path using the agent architecture specification between the first entry and the last entry in the interaction record. The optimal path can be determined as, for example, the path with the fewest state transitions, determined to be the shortest path such that the logical steps taken between the first entry and the last entry are the closest when compared to other paths between the first entry and last entry, the path that requires the fewest computing cycles.

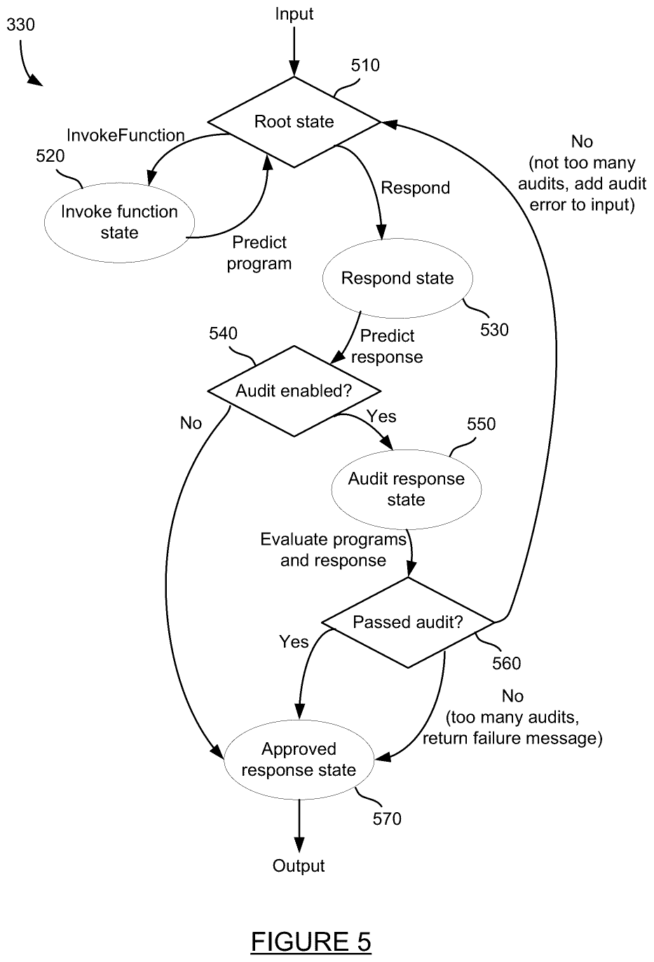

FIG. 5 illustrates an agent architecture specification. In the implementation of FIG. 5, the agent architecture specification is expressed as a state machine. The state machine begins at root state 510. Initially, at root state 510, a determination is made as to whether the state machine should respond to the client input or invoke a function based on the client input. The decision as to whether to respond or invoke a function can be made by submitting a prompt to a large language model with the input, conversation history (all or part of an interaction record), and other content. In some instances, the automated agent may cycle through an agent architecture specification multiple times in response to receiving a message from a client. The first iteration may execute a program and a second iteration may generate a response.

If a determination is made to invoke a function, the state machine transitions to invoke function state 520 and the function is invoked. The function may be selected from one or more functions listed in the API specification, and selected by logic within the automated agent or by a machine learning model. The invoked function executes, a result is generated or received, and the state machine transitions back to state 510.

If a determination is made at root state 510 to respond to the client, the state machine transitions to respond state 530 where a response is predicted. Predicting a response includes generating a response to the message received from the client in the interaction. After the response is generated, a determination is made as to whether an audit is enabled at state 540. In some instances, before a response is provided to a client, it may be audited to confirm it is a proper response without any errors.

If an audit is not enabled, the predicted response is approved at step 570 and provided as output in the interaction between the automated agent in the client. If an audit is enabled, the predicted response is audited at state 550. The state machine then transitions to step 560 to determine if the predicted response passed the audit. If the response passed the audit, the response is approved and provided as output at state 570.

If at state 560 a determination is made that a maximum number of audits has been conducted, the response will not pass the audit, a failure message is generated, and the failure message is provided to the client as the approved message at step 570. If the response does not pass the audit for reasons other than the number of audits performed, the response and the reasons for failure are sent back to root state 510 if there have not already been a threshold number of audits performed.

The state machine of FIG. 5 is one example of an agent architecture specification that may be used as decision logic and/or decision process for an automated agent processing a message from a client. In some instances, an automated agent may proceed through a state machine one or more iterations in response to each message received from a client. The state machine of FIG. 5 is intended merely as an example, and other variations of a state machine, with different states in different orders, can be used to process messages received from a client.

In some instances, an imputation engine builds a supplemented interaction record based on an existing interaction record in a backwards direction, from the last entry in the existing interaction record to the first entry in the interaction record. To build the supplemented interaction record, the imputation engine accesses the existing interaction record, accesses the last entry first, identifies what state in a state machine was the previous state, and executes actions and/or operations associated with the previous state. For each entry or message by an automated agent in the existing interaction record, the supplemented record can be supplemented or modified to indicate the actions associated states previous to the response generation state that resulted in the message from the automated agent.

FIGS. 6-11 illustrate supplemented interaction records. The interaction record of FIGS. 6-11 illustrate the progressive development of a supplemented interaction record based on the state machine of FIG. 5 and the existing interaction record of FIG. 4. The development of the supplemented interaction record works backwards from the last entry in the interaction record towards the first entry. The last entry in the record of FIG. 6 is entry 440, from the automated agent, confirming that the appointment has been scheduled. The entry is generated as a response from the automated agent in response to a previous entry from a client in the interaction record.

In the state machine of FIG. 5, a predicted response is audited before it is approved and output to a client. As such, in the partial supplemented interaction record 600 of FIG. 6, the interaction record is supplemented with data indicating that a predicted response was generated, the predicted response was submitted to an audit, and the automated agent determined that the predicted response passed the audit.

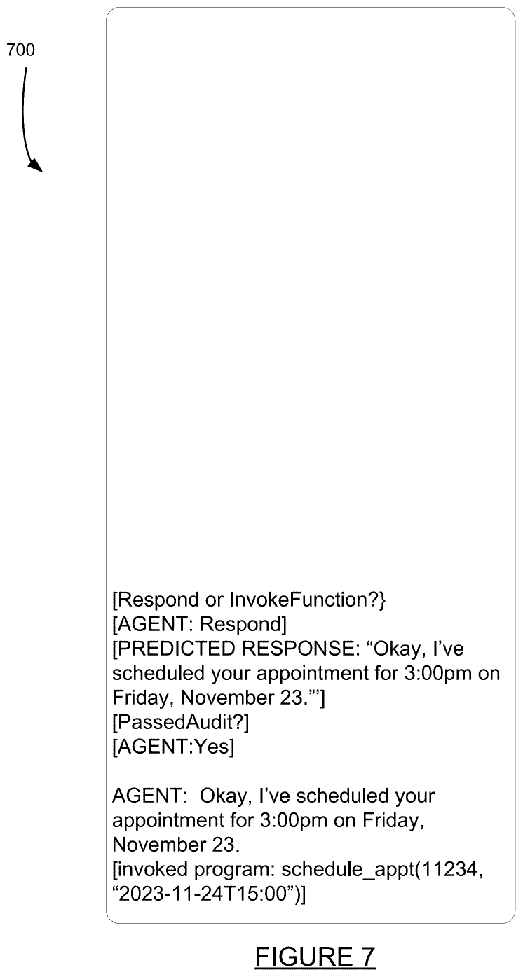

In the partially supplemented interaction record 700 of FIG. 7, the imputation agent determines that the automated agent determines, from the root state, whether the automated agent should predict a response or invoke a function. The automated agent determines that a response should be predicted. The response was determined to be entry 440 in the interaction record.

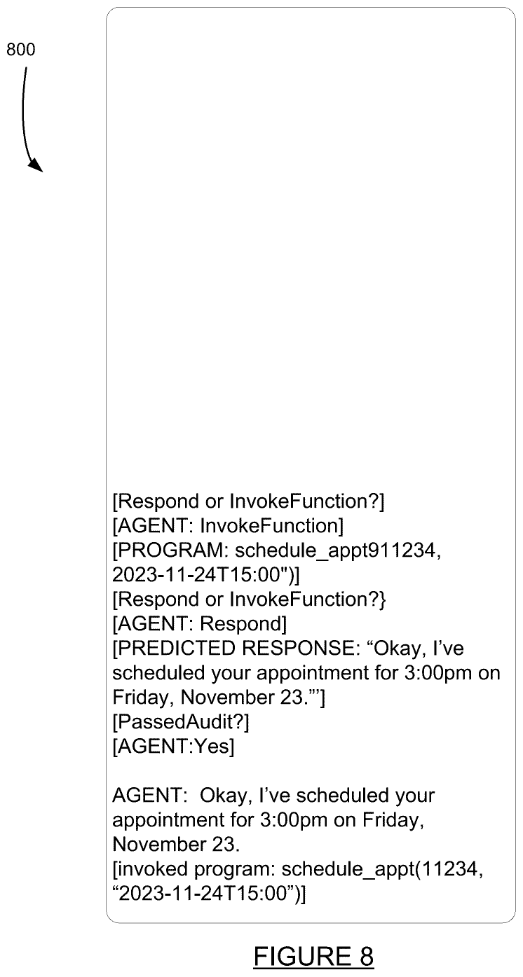

In the partially supplemented interaction record 800 of FIG. 8, the imputation agent determines that the automated agent determines, from the root state, whether the automated agent should predict a response or invoke a function. The automated agent determines that a function should be invoked. The function invoked is determined to be a program titled “schedule_appt911234,2023-11-24T1500.”

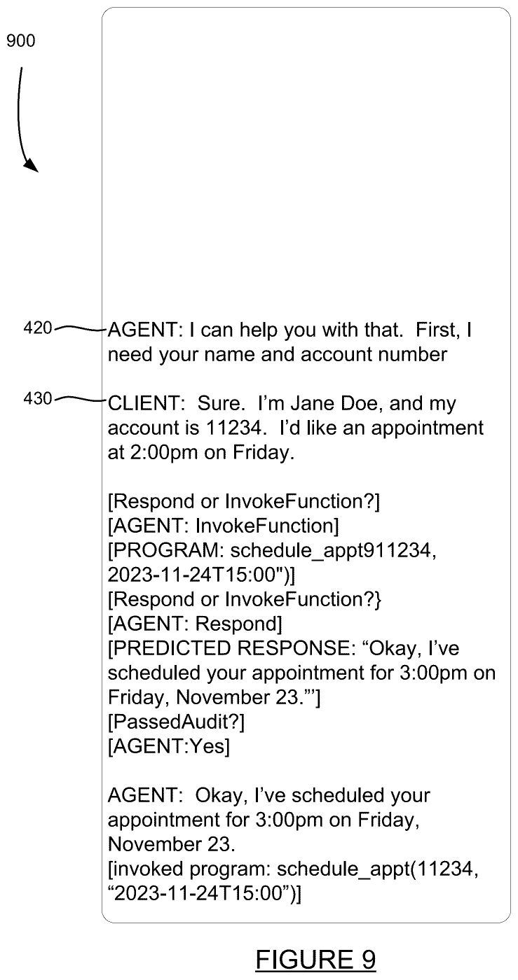

In the partially supplemented interaction record 900 of FIG. 9, a client provides a message indicating the client's name and account number, as well as when the client would like the appointment. This is in response to an automated agent communication indicating that the agent can help, but that the agent needs the client's name and account number.

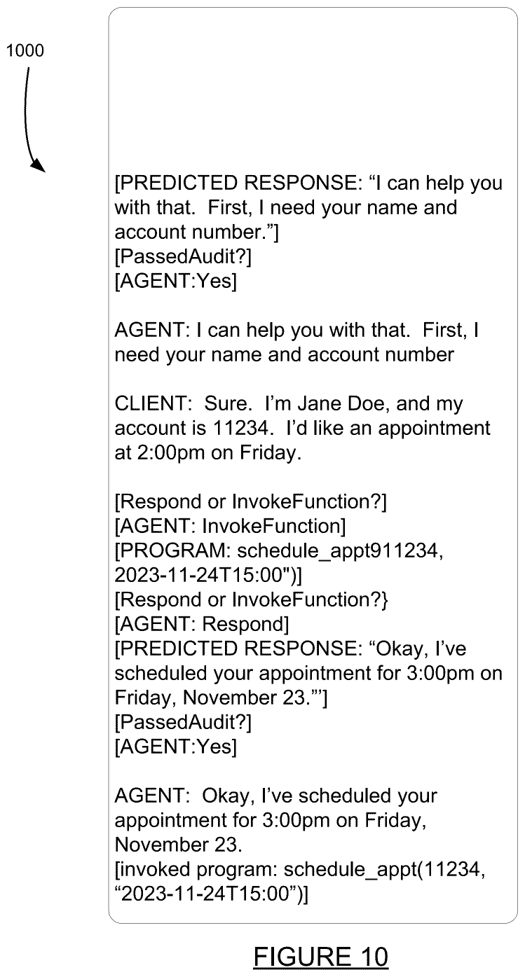

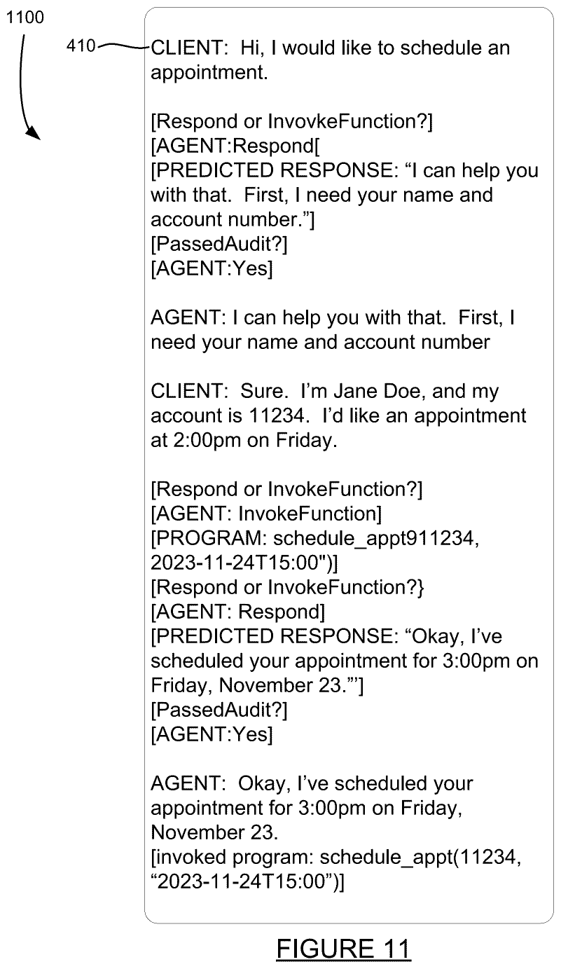

In the partially supplemented interaction record of FIG. 10, the automated agent, in order to provide a response to the client indicating that the automated agent needs the name and account number of the client, must generate the response. As such, the partially supplemented interaction record 1000 of FIG. 10 is supplemented by accessing a predicted response, subjecting the response to an audit, and then determining that the response passed the audit.

In the partially supplemented interaction record of FIG. 11, to provide a response, the automated agent must first generate a response. As such, the imputation agent determines, from the root state, whether to generate a response or invoke a function. The automated agent determines to generate a response. The automated agent response is generated in response to a client communication 410 indicating the client would like to schedule an appointment.

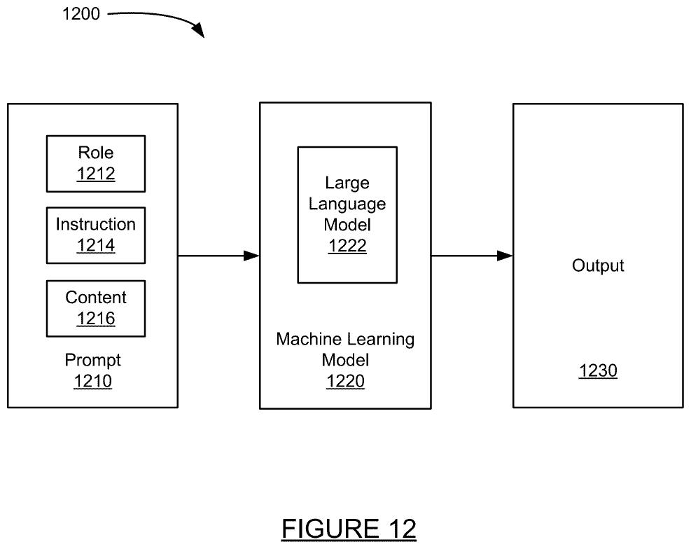

FIG. 12 is a flow chart illustrating data flow for a machine learning model. The block diagram of FIG. 4 includes prompt 410, machine learning model 420, and output 430.

Prompt 410 of FIG. 4 can be provided as input to a machine learning model 420. A prompt can include information or data such as a role 412, instructions 414, and content 416. The role indicates the authority level at which the automated agent is to assume while working to assist a user. For example, a role can include an entry-level customer service representative, a manager, a director, or some other customer service job with a particular level of permissions and rules that apply to what they can do and cannot do when assisting a customer.

Instructions 414 can indicate what the machine learning model (e.g., a large language model) is supposed to do with the other content provided in the prompt. For example, the machine learning model instructions may request, via instructions 414, an LLM to select the most relevant instructions from content 230 to train or guide a customer service representative having a specified role 210, determine if a predicted response was generated with each instruction followed correctly, determine what function to execute, determine whether or not to transition to a new state within a state machine, and so forth. The instructions can be retrieved or accessed from document 155 of vector database 150.

Content 416 may include data and/or information that can help a ML model or LLM generate an output. For an ML model, the content can include a stream of data that is put in a processable format (for example, normalized) for the ML model to read. For an LLM, the content can include a user inquiry, retrieved instructions, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 420 of FIG. 4 provides more detail for machine learning model 110 of FIG. 1. The ML model 420 may receive one or more inputs and provide an output. In some instances, the ML model may predict an output in the form of whether a policy was followed, whether a particular instruction is relevant, or some other prediction.

ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT-3 by OpenAI, or other LLM. In some instances, machine learning model 115 may be implemented by one or more other models or neural networks.

Output 430 is provided by machine learning model 420 in response to processing prompt 410 (e.g., an input). For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions, a policy, or a checklist item during a conversation with a user, the machine learning model may return a confidence score, prediction, or other indication as to whether the instructions were followed correctly by the automated agent.

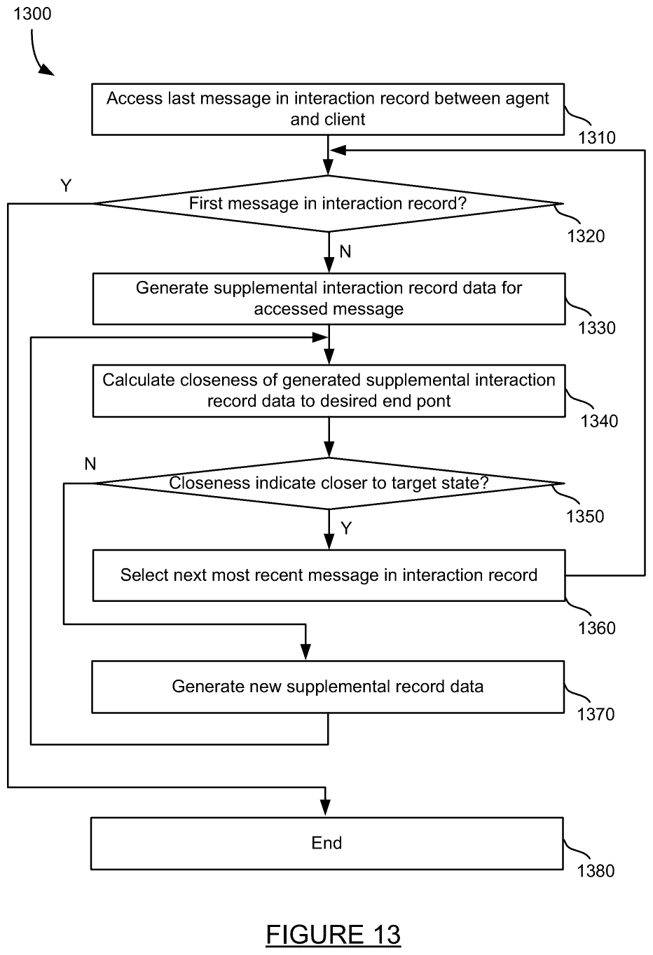

FIG. 13 is a method for imputing automated agent decision logic. The imputed automated agent decision logic is the optimal path of logic decisions between the first entry in an interaction record and the last entry in the interaction record.

A last message in an interaction record between an agent and a client is accessed at step 1310. A determination is made as to whether the accessed message is the first message in the interaction record at step 1320. If the accessed message is the first message in the interaction record, then there are no more messages to process and the method ends at step 1380. If the accessed message is not the first message, supplemented interaction record data is generated for the accessed message at step 1330.

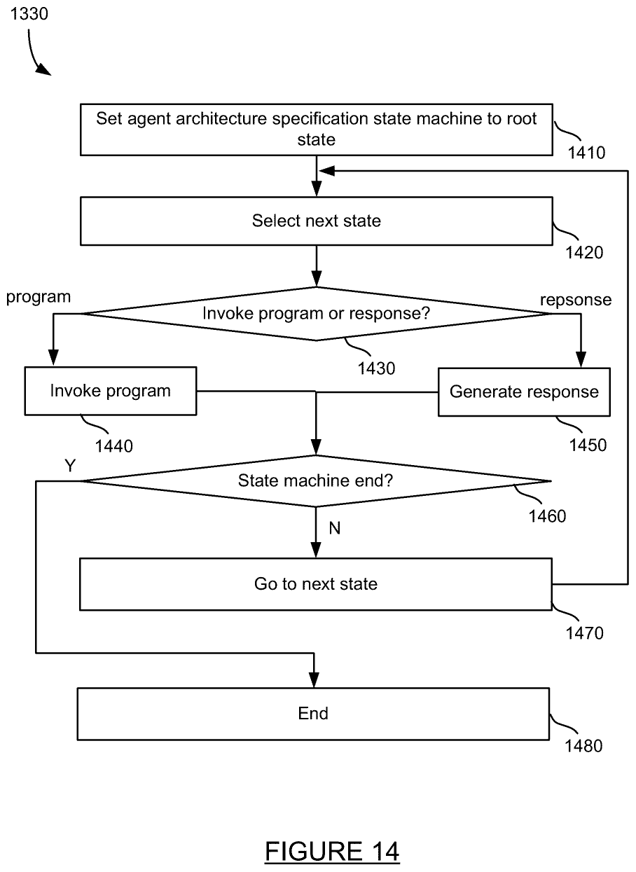

Generating a supplemented interaction record data at step 1330 may include going through a state machine or other decision logic to determine what the automated agent did to provide a response, invoke an action or function, or perform some other operation. More details for generating supplemented interaction record data are discussed with respect to the method of FIG. 14.

In some instances, generating supplemented interaction record data is performed using one or more machine learning models. A machine learning model may receive input with the message, API specification data, agent architecture specification, a request, and other data to determine how to supplement the interaction record. In some instances, the supplemented interaction record may be generated using a large language model, for example when input is provided as a prompt. More details for generating the supplemented interaction record data by a large language model is discussed with respect to the method of FIG. 16.

The closeness of the generated supplemented interaction record data to a desired endpoint is calculated at step 1340. In some instances, for each step of generating a supplemented interaction record, one or more calculations can be made to determine if the generated supplemented interaction record is getting closer or further away from the desired endpoint. The present system can generate the correct sequence that should have been performed by the automated agent to produce the existing interaction record. The correct sequence can be the most efficient sequence, the shortest sequence, the sequence that uses the fewest resources, and/or the fastest sequence. The correct sequence can be constructed as an ideal path for processing user requests in the interaction with the user, rather than the path actually taken by the automated agent previously or currently.

Calculating the closeness of a generated supplemented interaction record data to a desired endpoint is discussed in more detail below with respect to the method of FIG. 17.

A determination is made as to whether the closeness calculation of step 1340 indicates the path formed by the in-progress supplemented interaction record is getting closer to a target state (e.g., if working backwards, the first entry in the existing interaction record) at step 1350.

To determine if the supplemented interaction record path is getting closer to the target state in the interaction record, two or more calculated closeness values can be generated and compared. For example, the closeness of the most recent supplemented state and the previously supplemented state can be compared, the most recent supplemented state and other states that would be a transition (but were not selected to be transitioned to) from the previous supplemented state can be compared, and so forth.

If the closeness calculation indicates that the supplemented interaction record path is getting closer to a target state, the next most recent message in the interaction record is selected and the method continues to step 1320. If the closeness indicates it is not getting closer to the target state, a new supplemented record data is generated at step 1370.

At step 13470, the previously generated supplemented interaction data is replaced with replacement supplemented interaction data based on the closeness data. The new (i.e., replacement) supplemented interaction record data can be generated using the previously accessed message and an alternate calculation. In some instances, a different state may be selected, a variable in a function may be changed, a different response may be provided, or some other indication. Selecting new supplemented record data can also include removing the previously generated supplemented interaction record data from the supplemented interaction record. After generating the new supplemented record data, the method returns to step 1340.

FIG. 14 is a method for generating supplemented interaction record data. The method of FIG. 14 provides more detail for step 1330 of the method of FIG. 13. The present system can generate supplemented interaction record data based at least in part on an agent architecture specification, such as the state machine in FIG. 5. The method of FIG. 14 will illustrate generation of supplemented interaction data based on the FIG. 5 state machine, but other state machines, flow charts, or decision logic can be used.

An agent architecture specification state machine is set to a root state at step 1410. The state machine transitions to the next state at step 1420. A determination is then made as to whether a program should be invoked or a response should be generated at step 1430.

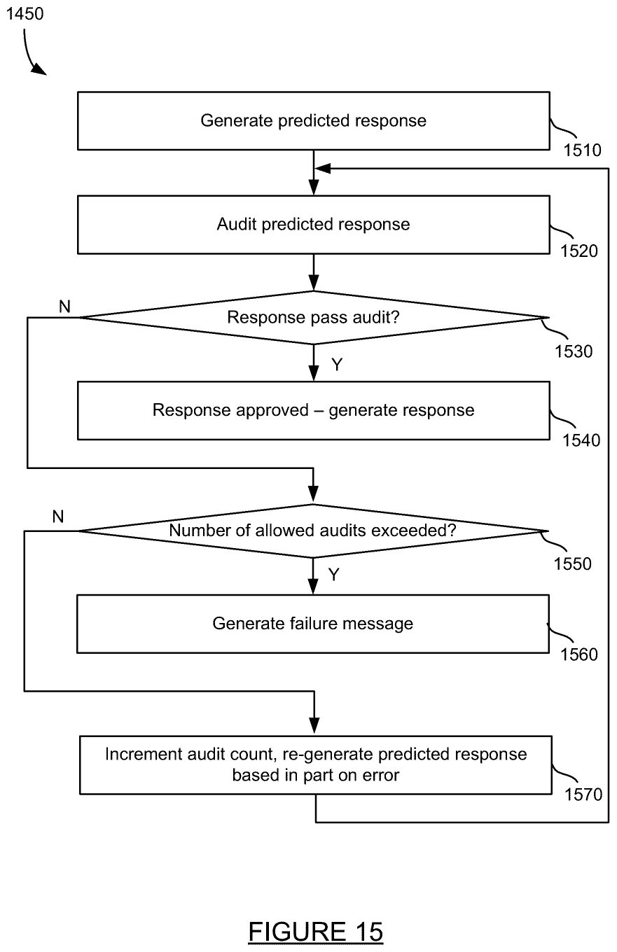

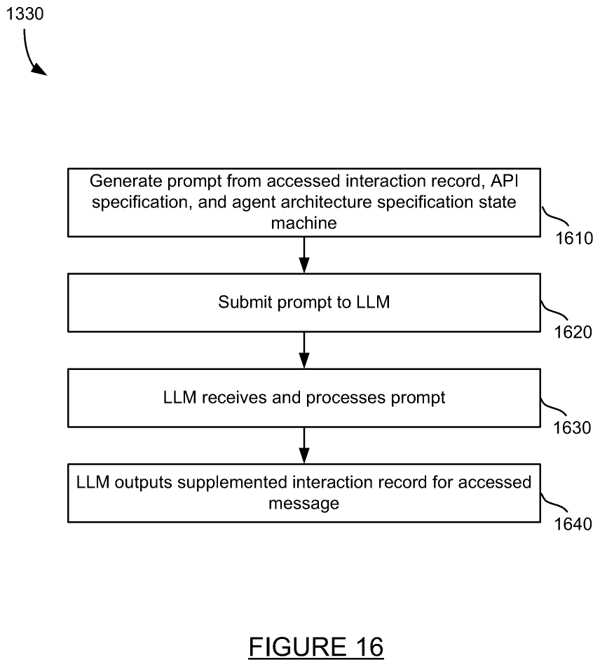

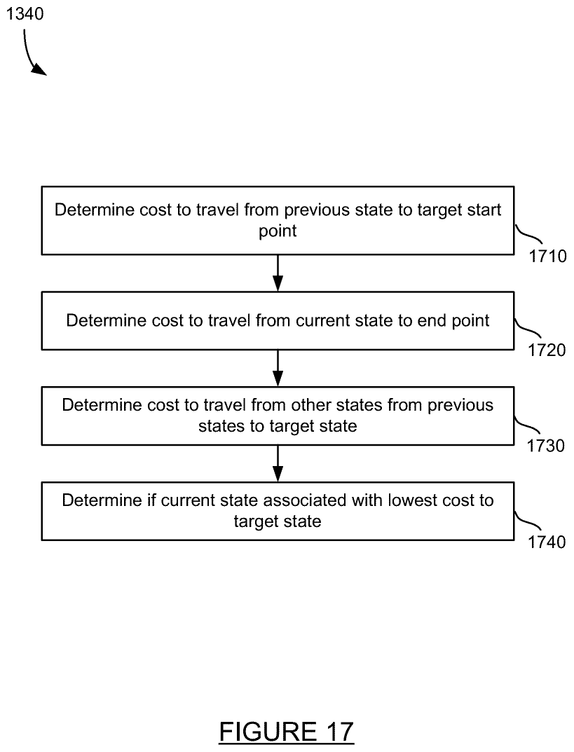

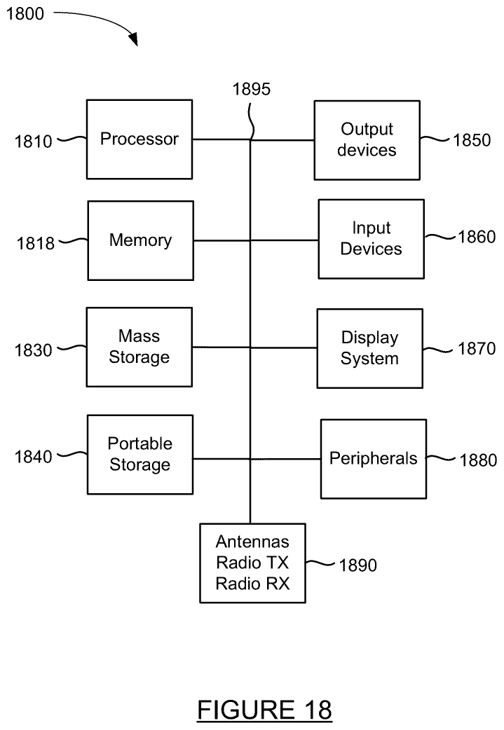

If a program should be invoked, the program is invoked at step 1440. After invoking the program, any result or output from the program is stored, and the method continues to step 1460. If a response should be generated, the response is generated and provided to a client at step 1450. In some instances, a response is generated as a predicted response and the predicted response audited to determine if it is acceptable. Generating a response is discussed in more detail with respect to the method of FIG. 15.

A determination is made as to whether the state machine ends at step 1460. If the state machine ends, the method of FIG. 14 ends at step 1480. If the state machine has not ended, the state machine transitions to the next state at step 1470 and the method returns to step 1420.

FIG. 15 is a method for generating a response. The method of FIG. 15 provides more detail for step 1450 of the method of FIG. 14. A predicted response is generated at step 1510. The response may be generated based on previous state results, the interaction record, and other data.

The predicted response is then audited at step 1520. Auditing the response may include submitting the interaction record, predicted response, and instructions to a LLM to determine if the generated response is acceptable.

A determination is made as to whether the response passes the audit at step 1530. If the response passes the audit, the response is approved and may be output in the interaction with a client at step 1540. If the response does not pass an audit, a determination is made as to whether the number of allowed audits has exceeded at step 1550. In some instances, for example for latency purposes, the number of audits may be restricted to a certain maximum number, such as three, five, six, ten, or some other number. If the number of audits has been exceeded, a failure message is generated as an approved message at step 1560 and the failure message is output to the client in the interaction. If the number of audits has not been exceeded, the audit count is incremented, the predicted response is regenerated based in part on the error detected in the audit, and the method of FIG. 15 returns to step 1520.

FIG. 16 is a method for generating supplemented interaction record data using an LLM. The method of FIG. 16 provides more detail for step 1330 of the method of FIG. 13, and provides an alternate method for generating a supplemented interaction record. A prompt is generated from an accessed interaction record, API specification, and an agent architecture specification at step 1610. The prompt is then submitted to a large language model at step 1620. The large language model receives the input and processes the prompt at step 1630. A large language model then outputs a supplemented interaction record for the accessed message at step 1640.

FIGS. 17 is a method for calculating closeness of generated supplemented interaction record data to a target end point. The method of FIG. 17 provides more detail for step 1340 of the method of FIG. 13. The closeness from the previous state to the target end state is determined at step 1710. The cost may be determined as a distance, number of steps or states, and other data. The cost to travel from the current state to the target end state is determined at step 1720. The cost to travel from other states that could have been transitioned to from the previous state to the target end state is determined at step 1730. A determination is then made as to whether the current state is the closest state to the target state at step 1740. Based on determining the closeness from different states to the target state, the automated agent can determine whether the generated path along interaction record is the best path, and in particular the most efficient path, between the endpoint in the starting target point.

FIG. 18 is a block diagram of a computing environment for implementing the present technology. System 1800 of FIG. 18 may be implemented in the contexts of the likes of machines that implement machine learning model 110, application server 180, chat application server 130, and simulation server 140. The computing system 1800 of FIG. 18 includes one or more processors 1810 and memory 1820. Main memory 1820 stores, in part, instructions and data for execution by processor 1810. Main memory 1820 can store the executable code when in operation. The system 1800 of FIG. 18 further includes a mass storage device 1830, portable storage medium drive(s) 1840, output devices 1850, user input devices 1860, a graphics display 1870, and peripheral devices 1880.

The components shown in FIG. 18 are depicted as being connected via a single bus 1895. However, the components may be connected through one or more data transport means. For example, processor unit 1810 and main memory 1820 may be connected via a local microprocessor bus, and the mass storage device 1830, peripheral device(s) 1880, portable storage device 1840, and display system 1870 may be connected via one or more input/output (I/O) buses.

Mass storage device 1830, which may be implemented with a magnetic disk drive, an optical disk drive, a flash drive, or other device, is a non-volatile storage device for storing data and instructions for use by processor unit 1810. Mass storage device 1830 can store the system software for implementing embodiments of the present invention for purposes of loading that software into main memory 1820.

Portable storage device 1840 operates in conjunction with a portable non-volatile storage medium, such as a floppy disk, compact disk or Digital video disc, USB drive, memory card or stick, or other portable or removable memory, to input and output data and code to and from the computer system 1800 of FIG. 18. The system software for implementing embodiments of the present invention may be stored on such a portable medium and input to the computer system 1800 via the portable storage device 1840.

Input devices 1860 provide a portion of a user interface. Input devices 1860 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1800 as shown in FIG. 18 includes output devices 1850. Examples of suitable output devices include speakers, printers, network interfaces, and monitors.

Display system 1870 may include a liquid crystal display (LCD) or other suitable display device. Display system 1870 receives textual and graphical information and processes the information for output to the display device. Display system 1870 may also receive input as a touch-screen.

Peripherals 1880 may include any type of computer support device to add additional functionality to the computer system. For example, peripheral device(s) 1880 may include a modem or a router, printer, and other device.

The system of 1800 may also include, in some implementations, antennas, radio transmitters and radio receivers 1890. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1800 of FIG. 18 are those typically found in computer systems that may be suitable for use with embodiments of the present invention and are intended to represent a broad category of such computer components that are well known in the art. Thus, the computer system 1800 of FIG. 18 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for generating a supplemented interaction record between an automated agent and a client, comprising:
accessing, by an imputation engine on a server, an existing interaction record between a client and an automated agent, an API specification, and an agent architecture specification, the existing interaction record associated with an interaction between the client and the automated agent that occurred in the past, the existing interaction record including at least one entry associated with an automated agent;
determining one or more logical steps associated with a correct sequence that could be performed by an automated agent in determining each entry by the automated agent in the existing interaction record; and
generating a supplemented interaction record based on the existing interaction record between a client and an automated agent, an API specification, and an agent architecture specification, the supplemented interaction record including additional data based on the one or more logical steps performed by the automated agent.

2. The method of claim 1, wherein the logical steps performed by the automated agent are determined in reverse order from a last entry to a first entry in the existing interaction record.

3. The method of claim 1, wherein the agent architecture specification includes a state machine.

4. The method of claim 1, wherein the logical steps include one of generating a response or invoking a function for each entry in the existing interaction record by the automated agent.

5. The method of claim 1, wherein the supplemented interaction record represents the most efficient logical path from the first entry in the existing interaction record first entry to the last entry in the existing interaction record.

6. The method of claim 1, wherein a closeness value is determined for a supplemented interaction record that is partially complete, the closeness value determined based on the current supplemented interaction record and the desired end point of the supplemented interaction record.

7. The method of claim 6, further comprising replacing supplemented interaction data with replacement supplemented interaction data based on the closeness data.

8. A non-transitory computer readable storage medium having embodied thereon a program, the program being executable by a processor to generate a supplemented interaction record between an automated agent and a client, the method comprising:
accessing, by an imputation engine on a server, an existing interaction record between a client and an automated agent, an API specification, and an agent architecture specification, the existing interaction record associated with an interaction between the client and the automated agent that occurred in the past, the existing interaction record including at least one entry associated with an automated agent;
determining one or more logical steps associated with a correct sequence that could be performed by an automated agent in determining each entry by the automated agent in the existing interaction record; and
generating a supplemented interaction record based on the existing interaction record between a client and an automated agent, an API specification, and an agent architecture specification, the supplemented interaction record including additional data based on the one or more logical steps performed by the automated agent.

9. The non-transitory computer readable storage medium of claim 8, wherein the logical steps performed by the automated agent are determined in reverse order from a last entry to a first entry in the existing interaction record.

10. The non-transitory computer readable storage medium of claim 8, wherein the agent architecture specification includes a state machine.

11. The non-transitory computer readable storage medium of claim 8, wherein the logical steps include one of generating a response or invoking a function for each entry in the existing interaction record by the automated agent.

12. The non-transitory computer readable storage medium of claim 8, wherein the supplemented interaction record represents the most efficient logical path from the first entry in the existing interaction record first entry to the last entry in the existing interaction record.

13. The non-transitory computer readable storage medium of claim 8, wherein a closeness value is determined for a supplemented interaction record that is partially complete, the closeness value determined based on the current supplemented interaction record and the desired end point of the supplemented interaction record.

14. The non-transitory computer readable storage medium of claim 13, further comprising replacing supplemented interaction data with replacement supplemented interaction data based on the closeness data.

15. A system for generating a supplemented interaction record between an automated agent and a client, comprising:
one or more servers, wherein each server includes a memory and a processor; and
one or more modules stored in the memory and executed by at least one of the one or more processors to access, by an imputation engine on a server, an existing interaction record between a client and an automated agent, an API specification, and an agent architecture specification, the existing interaction record associated with an interaction between the client and the automated agent that occurred in the past, the existing interaction record including at least one entry associated with an automated agent, determine one or more logical steps associated with a correct sequence that could be performed by an automated agent in determining each entry by the automated agent in the existing interaction record; and, and generate a supplemented interaction record based on the existing interaction record between a client and an automated agent, an API specification, and an agent architecture specification, the supplemented interaction record including additional data based on the one or more logical steps performed by the automated agent.

16. The system of claim 15, wherein the logical steps performed by the automated agent are determined in reverse order from a last entry to a first entry in the existing interaction record.

17. The system of claim 15, wherein the agent architecture specification includes a state machine.

18. The system of claim 15, wherein the logical steps include one of generating a response or invoking a function for each entry in the existing interaction record by the automated agent.

19. The system of claim 15, wherein the supplemented interaction record represents the most efficient logical path from the first entry in the existing interaction record first entry to the last entry in the existing interaction record.

20. The system of claim 15, wherein a closeness value is determined for a supplemented interaction record that is partially complete, the closeness value determined based on the current supplemented interaction record and the desired end point of the supplemented interaction record.
